(19) United States
(12) Patent Application Publication
(10) Pub. No.: US 2013/0204447 A1
(43) Pub. Date: Aug. 8, 2013

(54) WIND TURBINE WITH PRICE-OPTIMISED TURBINE LOAD CONTROL

(71) Applicants: Martin Huus Bjerge, Kibaek (DK); Per Egedal, Herning (DK); lb Frydendal, Fovling (DK); Hans Laurberg, Arhus C (DK)

(72) Inventors: Martin Huus Bjerge, Kibaek (DK); Per Egedal, Herning (DK); lb Frydendal, Fovling (DK); Hans Laurberg, Arhus C (DK)

(21) Appl. No.: 13/364,538

(22) Filed: Feb. 2, 2012

(51) Int. Cl. G06F 1/26; G05B 13/02

(52) U.S. Cl. 700/287

(57) ABSTRACT

A method of controlling the load of a wind turbine is provided. A rate of wear experienced by the wind turbine as a result of the current operating conditions of the wind turbine is determined. A control vector for controlling the wind turbine is determined based on the determined rate of wear. The load of the wind turbine is controlled in accordance with the determined control vector. Determining the control vector includes weighting the determined rate of wear by a cost of electricity value and determining the control vector based on the weighted rate of wear.

### FIELD OF INVENTION

The invention relates to a method of controlling load of a wind turbine in accordance with a rate of wear experienced by the wind turbine as a result of the current operating conditions.

### BACKGROUND OF INVENTION

From an economical point of view a wind turbine represents a major investment which is expected to return profit over the lifetime of the wind turbine. The lifetime of a wind turbine depends on the wear experienced by the wind turbine. For example, a wind turbine located in an area with only occasional strong winds will provide more power if its design is optimised for relatively low winds. However, such a wind turbine will experience much higher wear when operating at maximum power output during strong winds than a wind turbine located in an area where strong winds are typical and that is therefore designed for strong winds and accordingly will provide little power at low wind speeds. Accordingly the lifetime of the wind turbine may be shortened disproportionally when operating at high workloads. Another example may be gusty wind which may also cause disproportional stress not justified by an increased power output of the wind turbine.

### SUMMARY OF INVENTION

Thus, even though more wind power is harvested during strong winds and more electricity will be generated, the structural and thus economic damage caused by the high stress outbalance the benefit from the higher power output. Turbine Load Control (TLC) takes the wear caused by current operating conditions into account and aims at maximising the return-of-investment. Such TLC systems may throttle the power output if the rate of wear is too high.

It is an object of the present invention to provide for an improved method of controlling load of a wind turbine which maximises the economic benefit of a wind turbine.

Accordingly the present invention provides a method of controlling the load of a wind turbine, wherein a rate of wear experienced by the wind turbine as a result of the current operating conditions of the wind turbine is determined, a control vector for controlling the wind turbine is determined based on the determined rate of wear and wherein the load of the wind turbine is controlled in accordance with the determined control vector. According to the invention determining the control vector comprises weighting the determined rate of wear by a cost of electricity value and determining the control vector based on the weighted rate of wear.

The invention has an advantage in that it considers the changing market price of the electricity produced by the wind turbine. Moreover, existing TLC systems can be modified easily to make use of the invention by weighting the rate of wear by the current cost of electricity and controlling the wind turbine in accordance with this modified input value. Thus, if at a certain point in time the cost of electricity is high, a higher rate of wear may be acceptable. Accordingly, all TLC systems that take tear and wear into consideration for setting the operating parameters of the wind turbine can make use of the advantages provided by the present invention.

Weighting the determined rate of wear may include dividing the determined rate of wear by the cost of electricity value. Implementation of this embodiment of the invention is simple and leads to good results because a higher cost of electricity value will automatically lessen the influence of the actual wear on the TLC system while a low cost of electricity value will throttle the power output of the wind turbine even more if little profit is to be expected.

The cost of electricity value may be a relative cost of electricity value. The relative cost of electricity value may be a function of a current cost of electricity value and of an expected future cost of electricity value. Considering expected future cost of electricity values in addition to the current cost of electricity is advantageous because any extension or reduction of lifetime of the wind turbine due to the TLC will result in a profit or loss proportional to the cost of electricity towards the end of the lifetime of the wind turbine.

Alternatively the relative cost of electricity value may be a predetermined value. Such a predetermined value can be either set manually or provided as part of the control routine. Using predetermined values results in a cost effective implementation which is especially suitable for single wind turbines or relatively small wind farms.

In some embodiments of the invention the method may further comprise determining a current time. In such a case the predetermined value is selected based on the determined current time and from a data set comprising typical cost of electricity values as a function of time.

In an embodiment of the method the data set comprises typical cost of electricity values as a function of daytime. Typically the consumption of electric energy is high during midday and in the evenings while it is very low in the early morning hours. On week-ends the consumption may remain lower throughout the morning. Even though changes in this scheme may occur, the inventive method yields good results even when based on such a relatively simple model of the cost of electricity.

Alternatively or in addition the data set may comprise typical cost of electricity values as a function of season information. For some regions the consumption of electricity will be higher in the winter season than in the summer due to the increased use of electric light. In other regions there may be a higher consumption in summer times when air-conditioning is used broadly. Accordingly, in some embodiments of the invention the predetermined value may be selected based on or taking geographic data of the site of the wind turbine into account.

The inventive method may comprise receiving stock information online and computing the relative cost of electricity value based on the received stock information. In such a case, the relative cost of electricity value will reflect unforeseeable events allowing the method to be receptive to unexpected market developments. Embodiments of the invention using received stock information are especially suitable for larger wind farms.

The stock information may comprise at least one of an electricity price, a gas price and a coal price as these prices have a direct influence on the profitability of the wind turbine.

The relative cost of electricity value may be computed based on a mathematical model which takes variations in the received stock information into account. A suitable mathematical model could be based on predictors as known from control theory.

All embodiments of the invention may further include measuring stress conditions. Such stress conditions may be measured by measuring temperatures, hydraulic pressures, wind speed, vibrations, acceleration of the wind turbine's tower head, oil level or even by receiving corresponding data from other wind turbines of the same wind farm which are located away from the present wind turbine in a current direction of wind. In such cases determining the rate of wear will be based at least in part on the measured stress conditions.

The rate of wear may be expressed as a loss of an initial value of the wind turbine over a unit time, for example as USD/hour or [symbol] /hour. Expressing the rate of wear in such a way simplifies determining a remaining value of the wind turbine and assessing the current rate of wear in the view of the current or expected cost of electricity.

The method of the invention may further include updating the initial value of the wind turbine. This allows for considering changing costs (usually decreasing costs) for a comparable wind turbine which may, for example, lead to the conclusion that a higher rate of wear is acceptable if the same amount of power produced by the present wind turbine can be produced by a less expensive new wind turbine or if worn out parts of the wind turbine can be replaced for a lower price.

In some embodiments of the invention a cumulated wear may be calculated from the determined rate of wear. The cumulated wear can then be used to control the load of the wind turbine. E.g. the cumulated wear can be compared to an expected cumulated wear based on the cumulated operating time of the wind turbine. If the result of the comparison yields that the cumulated wear is lower than expected, the power output of the wind turbine can be increased even when the cost of electricity is relatively low. If, on the other hand, the cumulated wear is higher than expected, the power output of the wind turbine can be decreased even more during times when moderate or even high wear rates meet low costs of electricity.

A second aspect of the invention provides a software storage medium comprising program code which, when executed on a controller of a wind turbine or on a controller of a wind park, causes the controller to execute the method of the present invention.

### BRIEF DESCRIPTION OF THE DRAWINGS

Further features, properties and advantages of the present invention will be clear from the following description of embodiments of the invention with reference to the accompanying figures.

FIG. 1 shows a wind turbine adapted for carrying out the method of the present invention.

FIG. 2 shows an example of a data set comprising typical cost of electricity values as a function of daytime.

FIG. 3 shows the energy price at the European Energy Exchange (EEX) over a time period of several years.

### DETAILED DESCRIPTION OF INVENTION

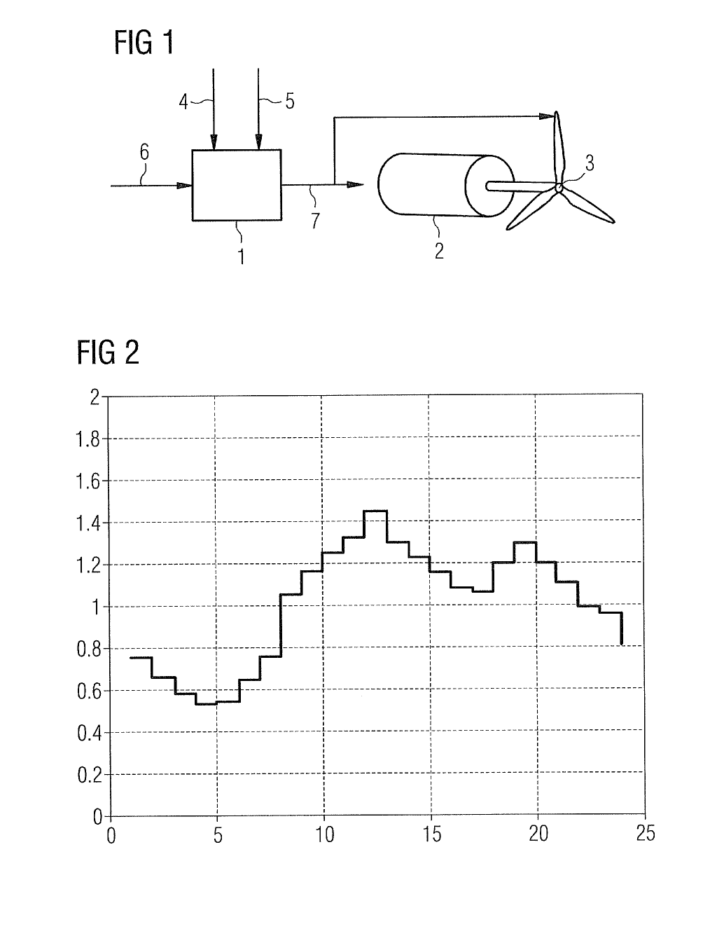

FIG. 1 shows a wind turbine adapted for carrying out the method of the present invention. The wind turbine comprises a rotor 3 which drives a power generator 2 for producing electric power. A controller 1 is provided for controlling the power generator 2 and the rotor 3. For example, the controller 1 may provide a control vector 7 comprising reference values such as a reference generator torque and a reference pitch angle to the power generator 2 and to the rotor 3, respectively, in order to control the power output of the wind turbine. The reference values of the control vector 7 are determined by the controller I in accordance with measured data 5 which may include environmental data such as wind speed, temperature or air pressure and measured operating parameters of the wind turbine such as rotor speed or rotor tip speed.

The controller 1 may form part of the wind turbine itself or of a central control instance such as a wind park controller. It could also be implemented as a distributed controller comprising control means in the wind turbine and central control means at the same time.

According to the invention the controller 1 also determines a rate of wear. This can be based on either one of or a combination of the current operating parameters of the wind turbine or on measured stress conditions 4 such as temperatures, hydraulic pressures, wind speed, vibrations, acceleration of the wind turbine's tower head, oil level or corresponding data received from other wind turbines of the same wind farm which are located away from the present wind turbine in a current direction of wind. According to the invention the determined rate of wear will be weighted by a cost of electricity value 6. The cost of electricity value can be determined in one of several different ways. For example, it can be set manually by operating staff or it can be selected from a data set comprising typical cost of electricity values. Furthermore it can be a function of a current cost of electricity value and of an expected future cost of electricity value. Other possibilities include computing the cost of electricity value based on stock information received online or using a mathematical model.

FIG. 2 shows an example of a data set comprising typical cost of electricity values as a function of daytime (given in hours). The typical cost is normalised using a mean value of the typical cost of electricity values. As can be seen from FIG. 2, the cost of electricity is typically very low in the early morning hours, i.e. between approximately 2 a.m. and 7 a.m., while it is typically very high around midday and in the evening, i.e. approximately between 11 a.m. and 1 p.m. and between 7 p.m. and 9 p.m., respectively. Accordingly, a higher rate of wear may be acceptable during midday and evenings while the exceptionally low typical cost of electricity in the early morning may lead to an even lower level of acceptable rate of wear.

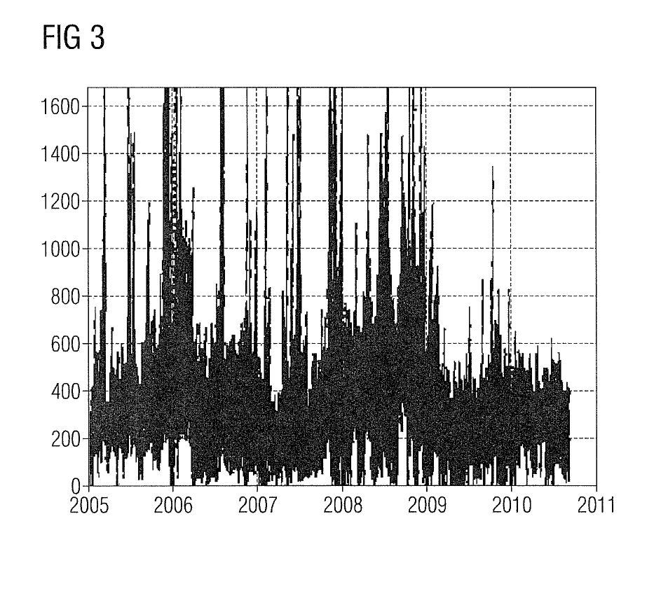

FIG. 3 shows the energy price at the European Energy Exchange (EEX) over a time period of several years. The price is given as Danish krones (DKK) per MWh. As can be seen, the energy price varies by several hundred percent within relatively short time periods. Thus, exemplary embodiments of the invention may use real-time values received online for weighting the determined rate of wear. It is also possible to use statistical analysis of the variation of the energy price for predicting a future cost of electricity.

While the invention has been described by referring to specific embodiments and illustrations thereof, it is to be understood that the invention is not limited to the specific form of the embodiments shown and described herein, and that many changes and modifications may be made thereto within the scope of the appended claims by one of ordinary skill in the art.

1. A method of controlling the load of a wind turbine,
determining a rate of wear experienced by the wind turbine as a result of the current operating conditions of the wind turbine;
weighting the determined rate of ware by a cost of electricity value;
determining a control vector which controls the wind turbine based on the weighted rate of wear; and
controlling the load of the wind turbine with the determined control vector.

2. The method of claim 1,
wherein weighting the determined rate of wear includes dividing the determined rate of wear by the cost of electricity value.

3. The method of claim 1,
wherein the cost of electricity value is a relative cost of electricity value.

4. The method of claim 3,
wherein the cost of electricity value is a relative cost of electricity value.

5. The method of claim 3,
wherein the relative cost of electricity value is a function of a current cost of electricity value and of an expected future cost of electricity value.

6. The method of claim 3,
wherein the relative cost of electricity value is a predetermined value.

7. The method of the claim 6, further comprising:
determining a current time,
wherein the predetermined value is selected based on the determined current time and from a data set comprising typical cost of electricity values as a function of time.

8. The method of the claim 7,
wherein the data set comprises typical cost of electricity values as a function of daytime.

9. The method of the claim 7,
wherein the data set comprises typical cost of electricity values as a function of season information.

10. The method of the claim 8,
wherein the data set comprises typical cost of electricity values as a function of season information.

11. The method of claim 3 further comprising:
receiving stock information online; and
computing the relative cost of electricity value based on the received stock information.

12. The method of the claim 11,
wherein the stock information comprises at least one price selected from the group consisting of an electricity price, a gas price and a coal price.

13. The method of the claim 11,
wherein the relative cost of electricity value is computed based on a mathematical model which takes variations in the received stock information into account.

14. The method of the claim 12,
wherein the relative cost of electricity value is computed based on a mathematical model which takes variations in the received stock information into account.

15. The method of one of the preceding claims, further comprising:
measuring stress conditions,
wherein determining the rate of wear is based on the measured stress conditions.

16. The method of claim 1,
wherein the rate of wear is expressed as a loss of an initial value of the wind turbine over a unit time.

17. The method of the claim 16, further including
updating the initial value of the wind turbine.

18. A software storage medium comprising program code which, when executed on a controller of a wind turbine or on a controller of a wind park, causes the controller to execute the method claim 1.
